(19) United States
(12) Patent Application Publication
(10) Pub. No.: US 2022/0063573 A1
(43) Pub. Date: Mar. 3, 2022

(54) DUAL ADAPTIVE COLLISION AVOIDANCE SYSTEM

(71) Applicant: Optimum Semiconductor Technologies Inc., Tarrytown, NY (US)

(72) Inventors: Samantha MURPHY, Nashua, NH (US); John GLOSSNER, Nashua, NH (US); Sabin Daniel IANCU, Pleasantville, NY (US)

(73) Assignee: Optimum Semiconductor Technologies Inc., Tarrytown, NY (US)

(21) Appl. No.: 17/275,007

(22) PCT Filed: Sep. 11, 2019
(86) PCT No.: PCT/US2019/050700

§ 371 Date: Mar. 10, 2021

Related U.S. Application Data
(60) Provisional application No. 62/731,112, filed on Sep. 14, 2018.

(51) Int. Cl. B60T 7/22

(52) U.S. Cl. CPC B60T 7/22; B60T 2201/022; B60T 2250/04; B60T 2250/02; B60T 2210/36

(57) ABSTRACT

An anti-collision system and method of a vehicle including a first sensor device to capture first sensor data associated with a first vehicle in front of the vehicle, a second sensor device to capture second sensor data associated with a second vehicle behind the vehicle, and a processing device to calculate, based on the first sensor data, a plurality of first parameters characterizing the first vehicle, calculate, based on the second sensor data, a plurality of second parameters characterizing the second vehicle, responsive to detecting a braking event by the first vehicle, determine, based on a rule taking into consideration at least one of the plurality of first parameters and at least one of the plurality of second parameters, a braking force for the vehicle, and generate a braking control signal that applies the braking force to brakes of the vehicle.

### CROSS-REFERENCE TO RELATED APPLICATION

This application claims priority to U.S. Provisional Application 62/731,112 filed Sep. 14, 2018, the content of which is incorporated by reference in its entirety.

### TECHNICAL FIELD

The present disclosure relates to automobile vehicles, and in particular, to a dual adaptive collision avoidance system for automobile vehicles.

### BACKGROUND

Automobiles may be equipped with a collision avoidance system (referred to as an anti-collision system) as a safety feature. The anti-collision system may work collaboratively with the braking system to prevent, or reduce the severity of, a collision.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a vehicle anti-collision system according to an implementation of the present disclosure.

FIG. 2 illustrates a British highway code for typical stopping distances.

FIG. 3 depicts a flow diagram of a method to calculate the braking force for anti-collision system according to an implementation of the present disclosure.

FIG. 5 depicts a block diagram of a computer system operating in accordance with one or more aspects of the present disclosure.

### DETAILED DESCRIPTION

Modern automobiles may include a sensor system to detect the environment surrounding the automobile and a computer system connected to the sensor system configured to determine, based on sensor data, the amount of force that should be applied to the brakes to avoid a collision, where the force may be generated automatically without human operator assistance. The sensor system may include a multitude of sensors to collect information about the environment. The sensors may include Light Detection and Ranging (LiDAR) sensors, proximity sensors, video cameras, global positioning system (GPS) sensors, motion sensors (e.g., odometers) etc. A LiDAR sensor can determine the distances between a reference point associated with the LiDAR sensor (e.g., a center point of the LiDAR) and objects in the environment within a certain distance range. A proximity sensor is a sensing device that is able to detect the presence of nearby objects without physical contacts. Examples of proximity sensors include Radar, Doppler sensors, optical sensors, sonar sensors, ultrasonic sensors, magnetic sensors, etc. A video camera may capture a sequence of time-coded images of the surrounding environment. The images may contain information relating to objects (e.g., human objects, other vehicles, signages, and obstacles) surrounding the automobile on the road. The GPS sensor may identify the location of the automobile. The motion sensor may determine the motion parameters (e.g., velocity, distance, etc.) of the automobile. The computer system onboard the automobile may include a processing device programmed to receive information from these sensors and, based on the received information, compute a braking force that would control the automobile to avoid a collision.

Many modern vehicles are equipped with the anti-collision systems. Typically, these systems monitor the vehicle in front of them using LiDAR sensors or proximity sensors. The onboard computer system may analyze the sensor data, calculate the distance between the present vehicle and other vehicles, and determine the speed/acceleration of the present vehicle to avoid a collision. Sometimes, the vehicle may be equipped with multiple sensors in the front and/or at the rear of the vehicle. Currently, information captured by the front sensors and the information captured by the rear sensors are processed independently and separately. The onboard computer system may process the front sensor data to avoid a frontal collision during forward movement of the present vehicle, and process the rear sensor data to avoid a rear collision during a backward movement of the present vehicle. The onboard computer system does not process both the front and rear sensor data in a coordinated way.

In certain situations, an automobile may need to avoid both the front and rear collision at the same time in a braking event such as, for example, a sudden stop of the front vehicle on the highway. A common example is multiple vehicles traveling within a lane sequentially toward a certain direction. For example, three vehicles may travel sequentially within a lane on a highway, where the middle vehicle may trail a front vehicle and is in front of a rear vehicle. In current anti-collision systems, the middle vehicle would only monitor the distance to the front vehicle to ensure no collision with the front vehicle. The middle vehicle would adjust its speed and decelerate with the objective to avoid a collision with the front vehicle. The collision system of the middle vehicle when braking does not take into consideration position and speed of the rear vehicle.

In a highway driving situation at high speed, the front vehicle may be forced to come to a sudden stop to avoid collisions with objects (e.g., a deer running across the highway) in front of the front vehicle. When in a sequence of vehicles, there is both a forward spacing between the front vehicle and the middle vehicle, and a backward spacing between the middle vehicle and the rear vehicle. Responsive to detecting an imminent collision event, the impulsive reaction of the operator of the middle vehicle is to apply the maximum breaking to avoid crashing into the front vehicle. This behavior may be encouraged by insurance policies that specify the driver who is rear-ended has no fault, thus no liability. Therefore, most drivers only attempt to avoid crashing into the vehicle ahead of them without regards to the vehicle behind them. This may make them vulnerable to a rear collisions.

To overcome the above-identified and other deficiencies of the current anti-collision systems, implementations of the disclosure may provide an improved anti-collision system for a vehicle including a front-facing sensor system and a back-facing sensor system to measure the relative speeds of the front vehicle and a rear vehicle with respect to the present vehicle, and to calculate a first distance between the front vehicle and the present vehicle and a second distance between the present vehicle and the rear vehicle. Thus, instead of breaking using the maximum force with a singular purpose to avoid the frontal collision, the anti-collision system may try to avoid both the front end and rear end collisions based on the measured relative speeds of and distances to the front and rear vehicles. If the anti-collision system determines that enough distance exists to allow the avoidance of a rear end collision, it may adaptively reduce the braking force to avoid a rear end collision under the condition that the braking force is sufficient to avoid the front end collision, thus avoiding the front end collision and the rear end collision in a coordinated way. Under certain situations, the anti-collision system may even determine that an acceleration of the present vehicle is necessary to avoid a rear end collision under the condition that the acceleration will not cause a front end collision.

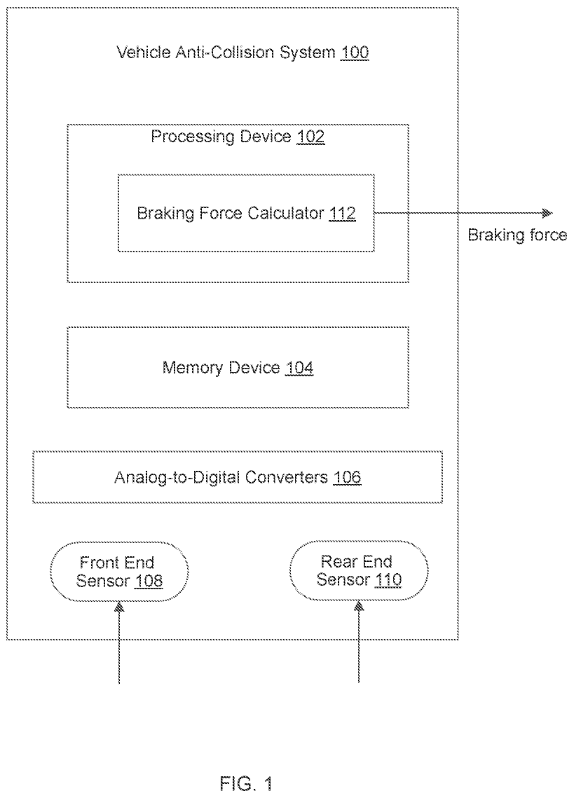

FIG. 1 illustrates a vehicle anti-collision system 100 according to an implementation of the present disclosure. Anti-collision system 100 can be a computing system onboard the vehicle that performs calculations associated with the driving of the vehicle. Referring to FIG. 1, anti-collision system 100 may include a processing device 102, a memory device 104, analog to digital converters (ADCs) 106, and front end sensor 108 and rear end sensor 110. Processing device 102 can be a hardware processor such as, for example, a central processing unit (CPU), a graphic processing unit (GPU), or a suitable hardware processing device that is programmable to perform calculations. Processing device 102 can be programmed to perform different tasks relating to operating the vehicle.

Anti-collision system 100 may further include a memory device 104 to store data and/or executable code that can be executed by processing device 102. Memory device 104 can be any suitable hardware storage such as, for example, random-access memory (RAM) device, hard disks, and/or cloud storage. In one implementation, anti-collision system 100 may include front end sensors 108 for collecting information on the environment in the front of the vehicle and a rear end sensors 110 for collecting information on the environment at the rear of the vehicle. Sensors 108, 110 may include one or more of LiDAR sensors, one or more proximity sensors, one or more video cameras, one or more GPS sensors, and one or more motion sensors. The one or more LiDAR sensors may be situated towards the front, the rear, and/or the sides of the autonomous vehicle. Thus, the one or more LiDAR sensors can detect objects (e.g., other vehicles and pedestrians) in all directions. Similarly, the one or more video cameras may be situated towards the front, the rear, and/or the sides of the autonomous vehicle. Thus, the one or more video cameras can also capture the images of objects in all directions, including objects from the front or from the rear.

Sensors 108, 110 may capture the information of the surrounding environment. The information may be in the form of analog signals. Anti-collision system 100 may further include one or more analog-to-digital converters (ADC) 106 to convert the analog signals received from sensors 106 into digital signals stored as data values in memory device 104. The data values can be the input to programs executed by processing device 102.

Processing device 102 may execute a braking force calculator 112 to compute, based on front end sensor data and rear end sensor data, a braking force function. The braking force function can be the amount of braking force applied to the brake as a function of time. A brake control component (not shown) may apply the calculated braking force to front and rear brakes and control the accelerations (or decelerations) and therefore, speeds of the vehicle.

The vehicles may move according to kinematics principles. Thus, each vehicle when traveling on the highway may be associated with a set of kinematic parameters including the velocity (v), the acceleration (a), and the distance (d), where the acceleration may include the increase rate of the vehicle velocity or the decrease rate of the vehicle velocity, and the distance may be the distance traveled between two time points. The acceleration (and thus the change of vehicle velocity) may be determined by the combination of forces applied to the vehicle and the mass of vehicle. The forces may include the driving force generated by the engine, the braking forces generated by the brake, and the friction force generated by the road surface on the tires. The processing device 102 may calculate the set of kinematic parameters by applying the combination of different forces along the direction of the vehicle travels (e.g., by subtracting the friction force from the driving force during drive or by combining the braking force and the friction force during braking) to the vehicle mass. Appendix A includes a description of the Newtonian laws that govern braking and vehicle stopping.

As shown in Appendix A, to bring the vehicle to a full stop, the combined force applied to the vehicle needs to result in a deceleration of the vehicle. There are many factors that affect the deceleration force exerted to stop a vehicle. Based on the motion equation, the mass of the vehicle (referred to as the vehicle parameter) is a factor affecting the calculation of acceleration. The factors affecting the force exerted on the vehicle may include road surface condition (wet vs dry road, air resistance, etc.), the weight of the vehicle (calculated from the mass), wear of the tires, longitudinal weight transfer under braking, and the braking force to the wheels. Different combinations of these factors may result in different stopping distances that may be calculated based on these factors.

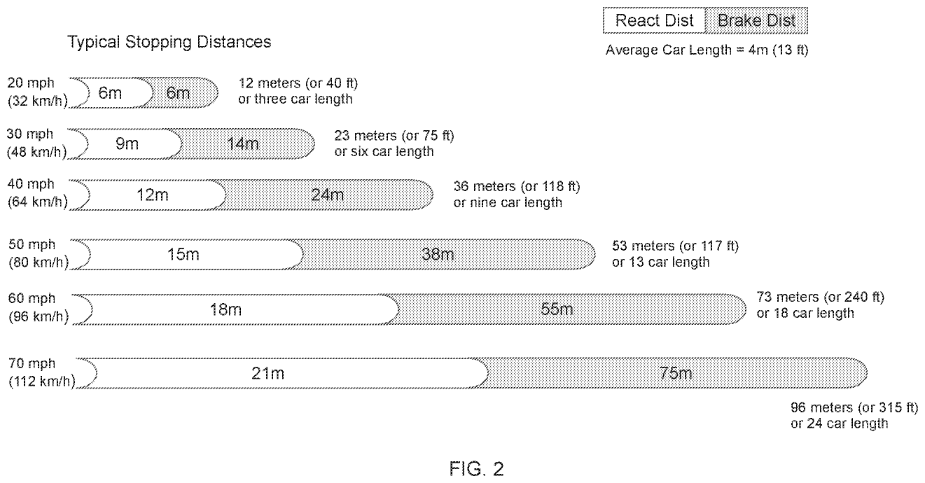

The distance that a vehicle may travel between the occurrence of a stopping event and the full stop may include a reaction distance and a braking distance. The reaction distance is the distance that the vehicle has traveled between the occurrence of the stopping event and the activation of the brake by the operator. Thus, the reaction distance relates to the average operator's reaction time. The braking distance is the distance that the vehicle has travelled between the brake activation and the full stop. Thus, the braking force applied to the brakes may determine the braking distance. FIG. 2 illustrates a British highway code for typical stopping distances. The distances are averaged across all vehicle classes. As shown in FIG. 2, the reaction distances and braking distances may be proportional to the velocity of the vehicle. The higher the velocity, the longer the reaction distance and braking distance. As noted above the actual braking force may vary significantly due to a number of factors. Modern high-performance vehicles may have stopping distances of less than 30 meters from a vehicle velocity of 100 km/hour for a 1000 kg vehicle. This provides more than twice the breaking force at 12.9 kilo Newtons. Taking into account different weights and braking technology, it is expected that stopping distances may vary by multiple 10's of meters for different vehicles.

Implementations of the disclosure may include anti-collision system of vehicle. The anti-collision system may include front end sensors and rear end sensors. The front end sensors may include a first video camera to capture images of the vehicle in front of the present vehicle and a first LiDAR sensor to measure the distance and the relative speed of the front vehicle with respect to the present vehicle. Similarly, the rear sensors may include a second video camera to capture images of the vehicle behind the present vehicle and a second LiDAR sensor to measure the distance and the relative speed of the rear vehicle with respect to the present vehicle. Based on the captured images and calculated distances and relative velocities, the processing device 102 may execute the braking force calculator 112 based on a set of rule. In one implementation, the rules may include generating the braking force to stop the present vehicle at an equal distance to the front vehicle and the rear vehicle, assuming that both the front vehicle and the back vehicle are both decelerating to a stop. In another implementation, the rules may include generating the braking force to stop the present vehicle farther away from the heavier of the front vehicle or the rear vehicle to allow more tolerance to the heavier vehicle, where the weight of the vehicles may have been determined based on the captured images.

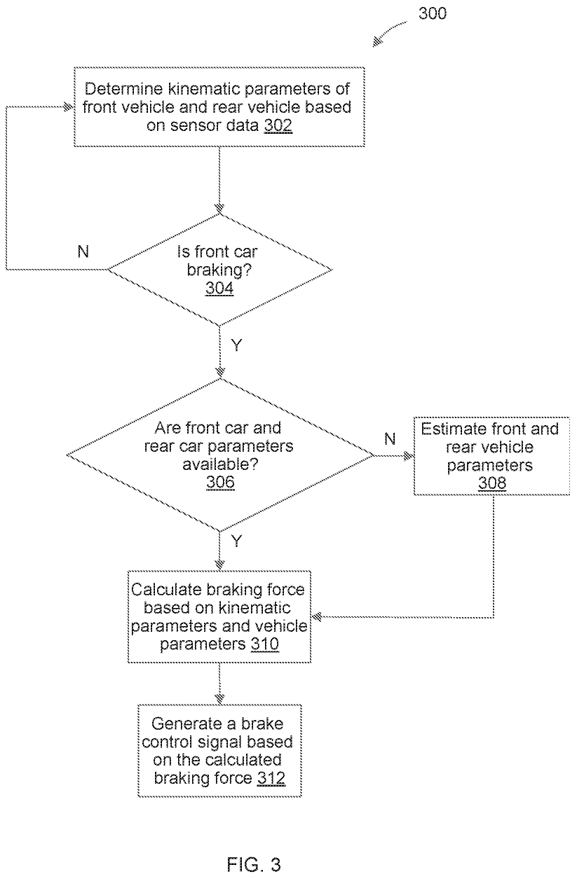

FIG. 3 depicts a flow diagram of a method 300 to calculate the braking force for anti-collision system according to an implementation of the present disclosure. Method 300 may be performed by processing devices that may comprise hardware (e.g., circuitry, dedicated logic), computer readable instructions (e.g., run on a general purpose computer system or a dedicated machine), or a combination of both. Method 300 and each of its individual functions, routines, subroutines, or operations may be performed by one or more processors of the processing device executing the method. In certain implementations, method 300 may be performed by a single processing thread. Alternatively, method 300 may be performed by two or more processing threads, each thread executing one or more individual functions, routines, subroutines, or operations of the method.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be needed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 300 may be performed by a processing device 302 executing braking force calculator 112 as shown in FIG. 1.

Referring to FIG. 3, at 302, processing device 102 may determine kinematic parameters of the front vehicle and the rear vehicle based on sensor data. The sensor data may include LiDAR data, and the kinematic parameters may include the relative distance and relative velocity between the present vehicle and the front vehicle, and the relative distance and relative velocity between the present vehicle and the rear vehicle or at discrete time points (e.g., at a constant sampling rate). The distances and relative velocities may be measured continuously as a function of time. Based on the relative distances and velocities of the front and rear vehicle, and the velocity of the present vehicle, processing device 102 may calculate the change rates (accelerations or decelerations) of the front vehicle and the rear vehicle. In one implementation, the calculation of the change rates can be achieved using Newtonian motion principles. In another implementation, the change rates can be determined using other means such as, for example, a machine learning model (e.g., a neural network model) that has been trained based on historical situations to determine the change rates.

At 304, processing device 102 may determine whether the front vehicle is braking. In one implementation, to determine whether the front vehicle is braking, processing device 102 may calculate estimations of the kinematic parameters associated with the front vehicle based on front sensor data. The kinematic parameters include the acceleration parameter of the front vehicle. For example, processing device 102 may determine that the front vehicle is braking if the acceleration parameter indicates a change from normal driving to deceleration or is not braking if the front vehicle maintains its speed (or in an accelerating state). Responsive to determining that there is no braking, processing device 102 may repeat the calculation at 302.

Responsive to determining that the front vehicle is braking, at 306, processing device 102 may determine whether the vehicle parameters of the front vehicle and the vehicle parameters of the rear vehicle are available. The vehicle parameters can include makes and models of the vehicles and the estimated weights of the vehicles. These parameters may previously have been estimated and stored in memory device 104. During operation, the front vehicle and the rear vehicle may change from time to time because lane changes. Therefore, processing device 102 may first determine whether the front vehicle (or rear vehicle) has changed. The processing device 102 may make the determination based on images captured by the video cameras. For example, processing device 102 may perform image recognition to determine the area corresponding to the plates of the front vehicle and the rear vehicle and determine the symbols (e.g., characters, numbers, and logos) on the plate. The processing device may determine whether the front vehicle or the rear vehicle has changed based on the recognized symbols on the plate of the front vehicle or symbols on the rear vehicle. Alternatively, processing device 102 may determine the area in the captured video images and determine, without symbol recognition, whether the front vehicle or rear vehicle has changed based on the pixel values in the area. For example, the processing device 102 may perform image matching (e.g., using image correlation or a neural network based matching algorithm) to determine whether there is a change of the plates or a change of the front vehicle or the rear vehicle. As such, processing device 102 of the present vehicle may constantly determine vehicle parameters based on video images and store the vehicle parameters of the front vehicle and the rear vehicle in a storage device such as memory device 104.

If the vehicle parameters are not available (e.g., due to a new front vehicle or a new rear vehicle), at 308, processing device 102 may calculate estimates of the vehicle parameters of the front vehicle and the rear vehicle. In one implementation, processing device may calculate the estimations of the vehicle parameters based on the images captured by the front video camera and the rear video camera equipped on the present vehicle. The braking force calculator 112 may include an object recognition component (not shown) that may determine the makes and models of the front and rear vehicles based on their images. Further, the object recognition component may optionally identify the number of occupants in the vehicle to further refine the estimates of the vehicle parameters.

The object recognition component may be implemented using neural network or any suitable image analysis approaches. Based on the recognized makes and models of the front and rear vehicle and optionally, the estimated number of occupants on these vehicles, processing device 102 may determine vehicle parameters. In one implementation, processing device 102 may determine the weights of the front vehicle and rear vehicle by looking up a table storing the weights of different makes and models of vehicles. Processing device 102 may determine the estimate of the weight of occupants based on an average weight of human objects. After calculating the estimates of vehicle parameters, processing device 102 may store the estimates in a storage device for future use.

In another implementation, instead of recognizing the makes and models of the front vehicle and the rear vehicle, the object recognition component may determine the classes of these vehicles. The classes may include compact, small, mid-size, full size, and truck. Processing device 102 may calculate an estimate of the vehicle parameters based on the classes using an average weight for the corresponding class.

If the vehicle parameters are available in the storage device, at 310, processing device 102 may calculate the braking force based on the calculated kinematic parameters and vehicle parameters. Based on the kinematic parameters and vehicle parameters of the front and rear vehicles, processing device 102 may calculate the braking force to avoid collisions with both front and rear vehicles according to a rule. In one implementation, the rule may include considerations to both the front vehicle and the rear vehicle. For example, the rule may include the calculation of the braking force as a function of time to cause the present vehicle to stop at a substantially equal distance to both the front vehicle and the rear vehicle when they also stop. The rule may also include the calculation of the braking force as a function of time to cause the present vehicle to stop at a point that the distance to the front vehicle and distance to the rear vehicle are determined as function of the estimated weights of the front vehicle and rear vehicle. For example, the present vehicle may stop at a point that is farther away from the heavier of the front and rear vehicles and is closer to the lighter of the front and rear vehicles. The braking force may be a function of time that is updated through time until the present vehicle makes a full stop. The braking force may generate an appropriate acceleration, maintenance of speed (no acceleration), or deceleration so as to avoid both front and rear collisions. In one implementation, the braking force may cause the present vehicle to move in changing operational states such as, for example, decreasing deceleration rate, no deceleration or acceleration, increasing deceleration rate from no deceleration or acceleration, decreasing deceleration rate, stop. The states may be changed until reaching a stop point specified by the rule. Thus, the braking force applied to the vehicle is dynamically calculated based on the front and rear sensor data, and changed to achieve the stop point.

At 312, processing device 102 may generate a braking control signal based on the calculated braking force. The braking control signal may control, without human operator intervention, the braking of the present vehicle to avoid both frontal and rear collisions.

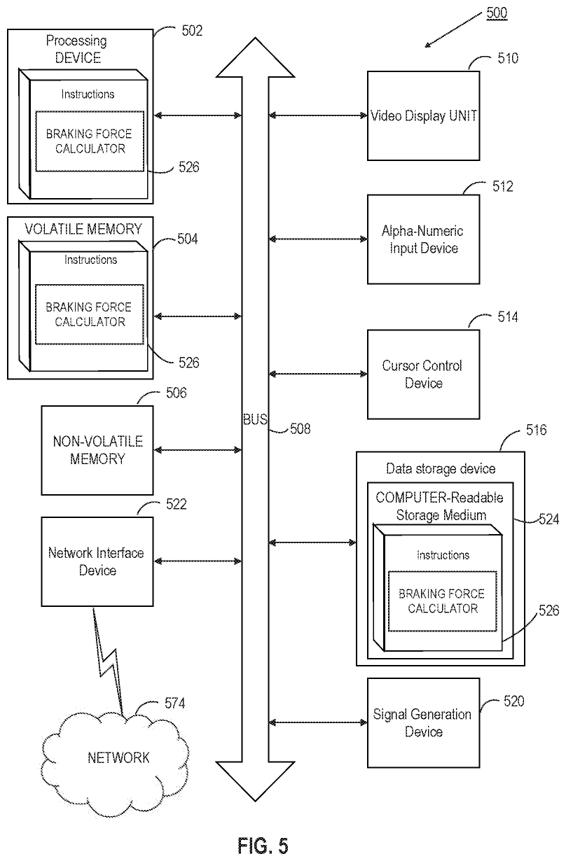

FIG. 5 depicts a block diagram of a computer system operating in accordance with one or more aspects of the present disclosure. In various illustrative examples, computer system 500 may be the anti-collision system 100 of FIG. 1.

In certain implementations, computer system 500 may be connected (e.g., via a network, such as a Local Area Network (LAN), an intranet, an extranet, or the Internet) to other computer systems. Computer system 500 may operate in the capacity of a server or a client computer in a client-server environment, or as a peer computer in a peer-to-peer or distributed network environment. Computer system 500 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 500 may include a processing device 502, a volatile memory 504 (e.g., random access memory (RAM)), a non-volatile memory 506 (e.g., read-only memory (ROM) or electrically-erasable programmable ROM (EEPROM)), and a data storage device 516, which may communicate with each other via a bus 508.

Processing device 502 may be provided by one or more processors such as a general purpose processor (such as, for example, a complex instruction set computing (CISC) microprocessor, a reduced instruction set computing (RISC) microprocessor, a very long instruction word (VLIW) microprocessor, a variable length vector (VLV) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 500 may further include a network interface device 522. Computer system 500 also may include a video display unit 510 (e.g., an LCD), an alphanumeric input device 512 (e.g., a keyboard), a cursor control device 514 (e.g., a mouse), and a signal generation device 520.

Data storage device 516 may include a non-transitory computer-readable storage medium 524 on which may store instructions 526 encoding any one or more of the methods or functions described herein, including instructions of the braking force calculator 112 of FIG. 1 for implementing method 300.

Instructions 526 may also reside, completely or partially, within volatile memory 504 and/or within processing device 502 during execution thereof by computer system 500, hence, volatile memory 504 and processing device 502 may also constitute machine-readable storage media.

While computer-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “associating,” “determining,” “updating” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform method 300 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

### APPENDIX A

Table 1 shows the basic laws of Newtonian physics that govern braking and stopping.

TABLE 1

| | General Formulas |
|---|---|
| Acceleration | −Force_{brake} = ma |
| | $Therefore α = \frac{- {Force}_{brake}}{m}$ |
| Velocity | $\begin{matrix}v ( t ) = \int adt = \int \frac{- {Force}_{brake}}{m} dt = \\ \frac{- {Force}_{brake}}{m} t + Constant 1\end{matrix}$ |
| | At time t = 0, let v(0) = v₀. Substituting into the above: |
| | ${v}_{0} = \frac{- {Force}_{brake}}{m} ( 0 ) + Constant 1$ |
| | Therefore Constant1 = v₀ and |
| | $v ( t ) = \frac{- {Force}_{brake}}{m} t + {v}_{0}$ |
| Distance | $\begin{matrix}d ( t ) = \int v ( t ) dt = \\ \int ( \frac{- {Force}_{brake}}{m} t + {v}_{0} ) dt = \\ \frac{- {Force}_{brake}}{2 m} {t}^{2} + {v}_{0} t + Constant 2\end{matrix}$ |
| | At time t = 0, let d(0), = d₀. Substituting into the above: |
| | $\begin{matrix}{d}_{0} = ( \frac{- {Force}_{brake}}{2 m} ) ( 0 ) + \\ {v}_{0} ( 0 ) + Constant 2\end{matrix}$ |
| | Therefore Constant2 = d₀ and |
| | $d ( t ) = \frac{- {Force}_{brake}}{2 m} {t}^{2} + {v}_{0} t + {d}_{0}$ |
| Stopping time | When the vehicle stops, the velocity is equal to 0 |
| | $v ( t ) = 0 = \frac{- {Force}_{brake}}{m} {t}_{stop} + {v}_{0}$ |
| | ${t}_{stop} = \frac{{mv}_{0}}{{Force}_{brake}}$ |
| Stopping Distance | $\begin{matrix}{d}_{stop} = \frac{- {Force}_{brake}}{2 m} {t}_{stop}^{2} + {v}_{0} {t}_{stop} = \\ \frac{- {Force}_{brake}}{2 m} {( \frac{{mv}_{0}}{{Force}_{brake}} )}^{2} + \\ {v}_{0} ( \frac{{mv}_{0}}{{Force}_{brake}} ) = \\ \frac{{mv}_{0}^{2}}{2 {Force}_{break}}\end{matrix}$ |

1. An anti-collision system of a vehicle, comprising:
a first senor device to capture first sensor data associated with a first vehicle in front of the vehicle;
a second sensor device to capture second sensor data associated with a second vehicle behind the vehicle; and
a processing device, communicatively coupled to the first sensor device and the second sensor device, to:
calculate, based on the first sensor data, a plurality of first parameters characterizing the first vehicle;
calculate, based on the second sensor data, a plurality of second parameters characterizing the second vehicle;
responsive to detecting a braking event by the first vehicle, determine, based on a rule taking into consideration at least one of the plurality of first parameters and at least one of the plurality of second parameters, a braking force for the vehicle; and
generate a braking control signal that applies the braking force to brakes of the vehicle.

2. The anti-collision system of claim 1, wherein the first sensor device comprises at least one of a first LiDAR sensor, a first proximity sensor, a first video camera, a first global positioning system (GPS), or a first motion sensor, and wherein the second sensor device comprises at least one of a second LiDAR sensor, a second proximity sensor, a second video camera, a second global positioning system (GPS).

3. The anti-collision system of claim 1, wherein the first sensor data comprise at least one of:
a plurality of first distance values representing distances between the vehicle and the first vehicle at a first plurality of time points, or
a plurality of first images of the first vehicle captured at a second plurality of time points, and
wherein the first sensor data comprise at least one of:
a plurality of second distance values representing distances between the vehicle and the second vehicle at a third plurality of time points, or
a plurality of second images of the second vehicle captured at a fourth plurality of time points.

4. The anti-collision system of claim 3, wherein to calculate, based on the first sensor data, a plurality of first parameters characterizing the first vehicle, the processing device is to calculate, based on the plurality of first distance values and the plurality of first images, a plurality of first kinematic parameters characterizing the first vehicle, and
wherein to calculate, based on the second sensor data, a plurality of second parameters characterizing the second vehicle, the processing device is to calculate, based on the plurality of second distance values and the plurality of second images, a plurality of second kinematic parameters characterizing the second vehicle.

5. The anti-collision system of claim 4, wherein the plurality of first kinematic parameters characterizing the first vehicle comprise at least one of first velocity parameters, first acceleration parameters, or first weight parameters, and wherein the plurality of second kinematic parameters characterizing the second vehicle comprise at least one of second velocity parameters, second acceleration parameters, or second weight parameters.

6. The anti-collision system of claim 5, wherein detecting a braking event by the first vehicle comprises detecting a change in at least one of the first velocity parameters or the first acceleration parameters.

7. The anti-collision system of claim 5, wherein responsive to detecting a braking event by the first vehicle, to determine, based on a rule taking into consideration at least one of the plurality of first parameters and at least one of the plurality of second parameters, a braking force for the vehicle, the processing device is to:
determine, based on the rule taking into consideration the plurality of first kinematic parameters characterizing the first vehicle and the plurality of second kinematic parameters characterizing the second vehicle, the braking force as a function of time to stop the vehicle at a stop point.

8. The anti-collision system of claim 7, wherein the processing device is to:
determine whether the plurality of first parameters characterizing the first vehicle are available in a storage device;
responsive to determining that the plurality of first parameters characterizing the first vehicle are available in the storage device, retrieve the plurality of first parameters from the storage device;
responsive to determining that the plurality of first parameters characterizing the first vehicle are unavailable in the storage device, determine, based on the first sensor data, the plurality of first parameters, wherein the processing device is to determine a model of the first vehicle and a number of occupants in the first vehicle based on the plurality of first images; and
determine the first weight parameters based on the model of the first vehicle and the number of occupants in the first vehicle.

9. The anti-collision system of claim 7, wherein the processing device is to:
determine whether the plurality of second parameters characterizing the second vehicle are available in a storage device;
responsive to determining that the plurality of second parameters characterizing the second vehicle are available in the storage device, retrieve the plurality of second parameters from the storage device;
responsive to determining that the plurality of second parameters characterizing the second vehicle are unavailable in the storage device, determine, based on the second sensor data, the plurality of second parameters, wherein the processing device is to determine a model of the second vehicle and a number of occupants in the second vehicle based on the plurality of second images; and determine the second weight parameters based on the model of the second vehicle and the number of occupants in the second vehicle.

10. The anti-collision system of claim 7, wherein the rule comprises a first rule of stopping the present vehicle at the stop point with an equal distance to the first vehicle and the second vehicle when both the first vehicle and the second vehicle stop, and a second rule of stopping the present vehicle at the stop point with a first distance to the first vehicle and a second distance to the second vehicle, wherein a ratio of the first distance to the second distance matches a ratio of an estimated first weight of the first vehicle to an estimated weight of the second vehicle.

11. A method for operating an anti-collision system of a vehicle, comprising:
receiving, by a processing device, first sensor data associated with a first vehicle in front of the vehicle captured by a first sensor device communicatively coupled to the processing device;
receiving, by the processing device, second sensor data associated with a second vehicle behind the vehicle captured by a second sensor device communicatively coupled to the processing device;
calculating, by the processing device based on the first sensor data, a plurality of first parameters characterizing the first vehicle;
calculating, by the processing device based on the second sensor data, a plurality of second parameters characterizing the second vehicle;
responsive to detecting a braking event by the first vehicle, determining, based on a rule taking into consideration at least one of the plurality of first parameters and at least one of the plurality of second parameters, a braking force for the vehicle; and
generating a braking control signal that applies the braking force to brakes of the vehicle.

12. The method of claim 11, wherein the first sensor device comprises at least one of a first LiDAR sensor, a first proximity sensor, a first video camera, a first global positioning system (GPS), or a first motion sensor, and wherein the second sensor device comprises at least one of a second LiDAR sensor, a second proximity sensor, a second video camera, a second global positioning system (GPS).

13. The method of claim 11, wherein the first sensor data comprise at least one of:
a plurality of first distance values representing a distance between the vehicle and the first vehicle at a first plurality of time points, or
a plurality of first images of the first vehicle captured at a second plurality of time points, and
wherein the first sensor data comprise at least one of:
a plurality of second distance values representing a distance between the vehicle and the second vehicle at a third plurality of time points, or
a plurality of second images of the second vehicle captured at a fourth plurality of time points.

14. The method of claim 13, wherein calculating, by the processing device based on the first sensor data, a plurality of first parameters characterizing the first vehicle comprises calculating, based on the plurality of first distance values and the plurality of first images, a plurality of first kinematic parameters characterizing the first vehicle, and
wherein to calculating, by the processing device based on the second sensor data, a plurality of second parameters characterizing the second vehicle comprises calculating, based on the plurality of second distance values and the plurality of second images, a plurality of second kinematic parameters characterizing the second vehicle.

15. The method of claim 14, wherein the plurality of first kinematic parameters characterizing the first vehicle comprise at least one of first velocity parameters, first acceleration parameters, or first weight parameters, and wherein the plurality of second kinematic parameters characterizing the second vehicle comprise at least one of second velocity parameters, second acceleration parameters, or second weight parameters.

16. The method of claim 15, wherein detecting a braking event by the first vehicle comprises detecting a change in at least one of the first velocity parameters or the first acceleration parameters.

17. The method of claim 15, wherein responsive to detecting a braking event by the first vehicle, determining, based on a rule taking into consideration at least one of the plurality of first parameters and at least one of the plurality of second parameters, a braking force for the vehicle further comprises determining, based on the rule taking into consideration the plurality of first kinematic parameters characterizing the first vehicle and the plurality of second kinematic parameters characterizing the second vehicle, the braking force as a function of time to stop the vehicle at a stop point.

18. The method of claim 17, wherein the rule comprises a first rule of stopping the present vehicle at the stop point with an equal distance to the first vehicle and the second vehicle when both the first vehicle and the second vehicle stop, and a second rule of stopping the present vehicle at the stop point with a first distance to the first vehicle and a second distance to the second vehicle, wherein a ratio of the first distance to the second distance matches a ratio of an estimated first weight of the first vehicle to an estimated weight of the second vehicle.

19. A non-transitory machine-readable storage medium storing instructions which, when executed, cause a processing device to perform operations of an anti-collision system of a vehicle comprising:
receiving, by the processing device, first sensor data associated with a first vehicle in front of the vehicle captured by a first sensor device communicatively coupled to the processing device;
receiving, by the processing device, second sensor data associated with a second vehicle behind the vehicle captured by a second sensor device communicatively coupled to the processing device;
calculating, by the processing device based on the first sensor data, a plurality of first parameters characterizing the first vehicle;
calculating, by the processing device based on the second sensor data, a plurality of second parameters characterizing the second vehicle;
responsive to detecting a braking event by the first vehicle, determining, based on a rule taking into consideration at least one of the plurality of first parameters and at least one of the plurality of second parameters, a braking force for the vehicle; and
generating a braking control signal that applies the braking force to brakes of the vehicle.

20. The non-transitory machine-readable storage medium of claim 19, wherein the first sensor device comprises at least one of a first LiDAR sensor, a first proximity sensor, a first video camera, a first global positioning system (GPS), or a first motion sensor, and wherein the second sensor device comprises at least one of a second LiDAR sensor, a second proximity sensor, a second video camera, a second global positioning system (GPS).
